(19) United States
(12) Patent Application Publication
(10) Pub. No.: US 2020/0406798 A1
(43) Pub. Date: Dec. 31, 2020

(54) UPPER SEATBACK SUPPORT BLOCK

(71) Applicant: LEAR CORPORATION, Southfield, MI (US)

(72) Inventors: Raminder SINGH, Coventry (GB); Adrian John LEWIS, Warwickshire (GB)

(21) Appl. No.: 16/452,713

(22) Filed: Jun. 26, 2019

(51) Int. Cl. B60N 2/58; B64D 11/06; A47C 1/12; B60N 2/20; B60N 2/70

(52) U.S. Cl. CPC B60N 2/58; B64D 11/0647; B64D 11/064; B60N 2/20; B60N 2/70; A47C 1/12

(57) ABSTRACT

A vehicle seat assembly includes a seat bottom, a seatback pivotally attached to the seat bottom, and a trim cover disposed over the seatback. The seatback includes a foam cushion positioned on a seatback frame, the foam cushion having at least one plastic component embedded therein. The seatback further includes a rigid support panel embedded in the foam cushion proximate the at least one plastic component. The rigid support panel is positioned to support the trim cover over a void formed in the foam cushion at the at least one plastic component. A method of manufacturing a seatback with a rigid support block is also provided.

### TECHNICAL FIELD

The present application is directed to a support block for a vehicle seatback.

### BACKGROUND

Conventional seatbacks typically include a foam cushion disposed on a seatback frame. The conventional seatbacks have a trim cover secured over the foam cushion. At junctures between other components, such as plastic latches and bezels, as well as curves and corners of the seatback design, the trim cover may wrinkle at edges of the components, dimple into the foam, or even sag into gaps between the components and foam, causing bad aesthetics.

### SUMMARY

According to one or more embodiments, a vehicle seat assembly includes a seat bottom, a seatback pivotally attached to the seat bottom, and a trim cover disposed over the seatback. The seatback includes a foam cushion positioned on a seatback frame, the foam cushion having at least one plastic component embedded therein. The seatback further includes a rigid support panel embedded in the foam cushion proximate the at least one plastic component. The rigid support panel is positioned to support the trim cover over a void formed in the foam cushion at the at least one plastic component.

According to at least one embodiment, the rigid support panel may be positioned at a top end of the seatback and may include a horizontal portion extending across the top end. Further, the rigid support panel may include opposing end portions curving down away from the horizontal portion toward a bottom end of the seatback. In one or more embodiments, the rigid support panel may be an expanded polypropylene (EPP) support block. In at least one embodiment, a Shore Hardness of the rigid support panel may be greater than 50 Shore A. In certain embodiments the Shore Hardness of the rigid support panel may be 50 to 90 Shore A. In one or more embodiments, the rigid support panel may have a curved surface on a region facing away from the foam cushion for contacting the trim cover, and the curved surface may follow an arc with a minimum radius of 3.2 mm. In some embodiments, the curved surface may follow an arc having a radius of 3.2 mm to 10 mm.

According to one or more embodiments, a vehicle seatback includes a seatback frame having a top portion and a bottom portion opposite the top portion, the bottom portion configured to cooperate with a seat bottom; and a foam cushion disposed on the seatback frame, the cushion having a front side configured to support a passenger, and a rear side opposite the front side, and a top end and bottom end opposite the top end, corresponding with the top portion and bottom portion of the seatback frame, respectively. The seatback also includes a plastic component embedded in the foam cushion, the plastic component and foam cushion defining a void therebetween, and a rigid support panel more rigid than the foam cushion for supporting a trim cover. The rigid support panel is positioned over the void and the foam cushion.

According to at least one embodiment, the rigid support panel may be an expanded polypropylene (EPP) support block. In one or more embodiments, the rigid support panel may have a curved surface on a region facing away from the foam cushion for contacting the trim cover. In certain embodiments, the curved surface may follow an arc having a minimum radius of 3.2 mm. Further, in some embodiments, the arc may have a radius of 3.2 to 10 mm. In at least one embodiment, the plastic component and rigid support panel may be positioned at the top end of the seatback, and the rigid support panel may extend across the top end. In one or more embodiments, a Shore Hardness of the rigid support panel may be greater than 50 Shore A. In certain embodiments, the Shore Hardness of the rigid support panel may be 50 to 90 Shore A.

According to one or more embodiments, a method of manufacturing a seatback includes molding a rigid support block for supporting a trim cover on the seatback, positioning the rigid support block at a top end of a mold tool such that the rigid support block can be embedded in foam, forming a foam cushion on a seatback frame in the mold tool, the foam cushion having a front side for supporting a passenger, a rear side opposite the front side, and a top end extending above the seatback frame corresponding to the top end of the mold tool, and securing the trim cover over the foam cushion and rigid support block such that the trim cover is retained on the seatback.

According to at least one embodiment, molding the rigid support block may include injection-molding expanded polypropylene (EPP) to form the rigid support block. In one or more embodiments, molding the rigid support block may include forming a curved surface on a region of the rigid support block facing away from the foam cushion for supporting the trim cover. In certain embodiments, the curved surface may follow an arc having a minimum radius of 3.2 mm.

### BRIEF DESCRIPTION OF THE DRAWINGS

FIG. 1 is a perspective schematic illustration of a representative vehicle seat assembly according to an embodiment;

FIG. 2 is a rear view of a vehicle seatback, according to an embodiment;

FIG. 3A is a rear perspective view of a vehicle seatback, according to an embodiment;

FIG. 3B is a sectional view of the vehicle seatback of FIG. 3A, taken along line 3B-3B;

FIG. 3C is a sectional view of the vehicle seatback of FIG. 3A, taken along line 3C-3C;

FIG. 4A is a rear perspective view of a vehicle seatback, according to an embodiment;

FIG. 4B is a sectional schematic of the vehicle seatback of FIG. 4A, taken along line 4B-4B;

FIG. 5 is a partial rear view of a vehicle seatback, according to an embodiment; and

FIG. 6 is a flow chart showing the method of forming a vehicle seatback, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in any examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

According to one or more embodiments, a vehicle seat assembly includes a seatback with a rigid support block. The rigid support block allows a clean finish for the trim cover where foam components and plastic components form voids, while complying with Head Impact standards (e.g., ECE R21). Utilizing a support block also reduces wrinkling at the voids at junctures between foam and plastic components and at curves of the seatback design. The rigid support block can be designed and sized based on the seatback design in order to support the trim cover and maintain the trim cover aesthetic. Embodiments of the present disclosure are hereinafter described.

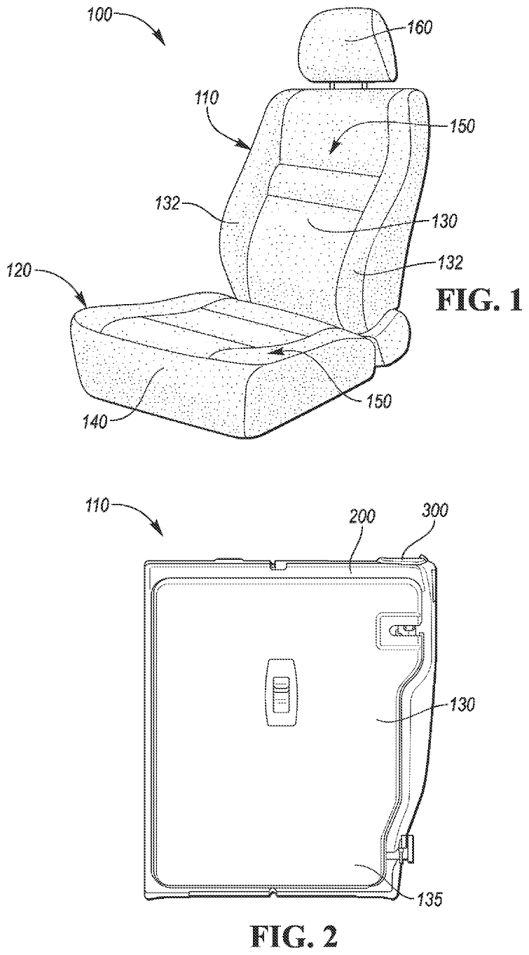

Referring now to the figures, where like numerals are used to designate like structure throughout to the drawings, a schematic vehicle seat assembly in accordance with at least one embodiment of the present disclosure is generally shown at 100 in FIG. 1.

FIG. 1 illustrates a schematic view of a vehicle seat assembly 100. The vehicle seat assembly 100 may be adapted for use in a motor vehicle, such as a car or truck, or may be used in with other seat assemblies including in aircraft, theater seats or any suitable seat assemblies. While the vehicle seat assembly 100 is illustrated in FIG. 1 to be a bucket seat assembly, it should be understood that the principles of the present disclosure are applicable to other types of seat assemblies, such as bench, captain, and other types of seat assemblies.

As shown in FIG. 1, the vehicle seat assembly 100 includes a seatback 110 and a seat bottom 120, connected to form seat assembly 100 and support an occupant in the vehicle. The seatback 110 may be pivotally mounted to seat bottom 120. The seat bottom 120 may be mounted on a seat frame (not shown) which can be removably secured to the vehicle floor. In some embodiments, the seatback 110 may include a head restraint 160.

In at least one embodiment, each of the seatback 110 and seat bottom 120 include foam cushion 130, 140, respectively. The foam cushion 130, 140 can be conventionally secured to a seat frame (not shown) by any method generally known in the art. Each foam cushion 130, 140 may be one or more foam parts, joined together to form the seat component. For example, the seatback 110 foam cushion 130 may include side bolster portions 132, or any other components to meet a selected design.

The seatback foam cushion 130 and the seat bottom foam cushion 140 can independently comprise any suitable comfort foam material such as, but not limited to, a suitable resilient polymer, and can independently be formed in any suitable manner. For example, the foam cushions 130, 140 may be formed of conventional polyurethane foam, soy-based foam, silicone, thermoplastic olefins, thermoplastic urethanes, and/or natural oil-based expanded polyurethanes, soy-based polyurethane, polymer fibers, non-woven polyester pads, latex foams and the like. The foam cushions 130, 140 are formed of any suitable comfort material that provides soft resilience as the seat assembly is deflected during use when an occupant is in a seated position. In at least one embodiment, suitable cushion materials will have a density of 1.5 to 4.5 pcf, in another embodiment of 2.0 to 3.75 pcf, and in yet other embodiments of 2.7 to 3.0 pcf. Density of the cushion material can be measured by ASTM test method No. D3574.

While the foam cushions 130, 140 can have any suitable size and configuration, in at least one embodiment, the cushions 130 and 140 independently have an average thickness of 5 to 100 mm, in other embodiments of 20 to 70 mm, and in yet other embodiments of 30 to 50 mm. In other embodiments, the seatback foam cushion 130 and the seat bottom foam cushion 140 independently have a length of 400 to 1400 mm and a width of 300 to 600 mm, and in yet other embodiments a length of 900 to 1200 mm and a width of 350 to 500 mm.

The vehicle seat assembly 100 also includes trim material 150 adapted to engage the foam cushions 130, 140 in a covering relationship. The trim material 150 may include any material commonly known in the art. By way of example, some of the known materials include cloth, leather, or polymers of sufficient quality and thickness for use in seat trim applications. Polymer trim materials may include a flexible closed cell polymer skin material such as polyvinyl, polyvinyl chloride (PVC), thermoplastic olefin (TPO), or thermoplastic urethane (TPU).

Additionally, materials for use as trim material 150 may include a foam backing (not shown, but generally known in the art) which may be manufactured from a variety of polymer foam materials. By way of example, the foam backing may be polyethylene, polypropylene, polyurethane, or a polystyrene foam. Optionally, a mesh or reinforcing material (not shown, but generally known in the art) such as fiberglass or nylon may be applied to the foam backing or back of trim material 150 for increasing strength without increasing rigidity.

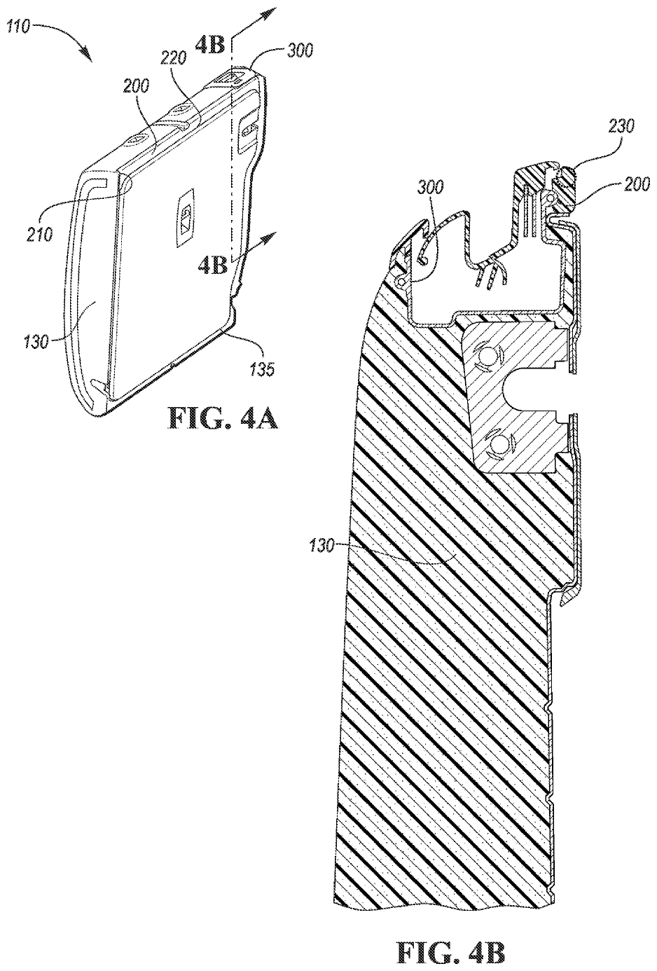

Referring to FIG. 2, a rear view of a vehicle seatback 110 is shown, according to an embodiment. Seatback 110 includes a foam cushion 130 disposed on a seatback frame (not shown). Foam cushion 130 is connected to the seatback frame by any generally known method, such as, but not limited to, molding. The vehicle seatback 110 may also include a cover layer 135, or any other known layer, for covering the rear side of the foam cushion 130. Foam cushion 130 of seatback 110 includes a top portion and a bottom portion. The bottom portion of the foam cushion 130 may be configured to cooperate with the foam cushion of the seat bottom (not shown). Seatback 110 also includes rigid support block 200. In certain embodiments, rigid support block 200 extends substantially horizontally along a top of the seatback 110, at the top portion of the foam cushion 130. The rigid support block 200 is hereinafter interchangeably referred to as the rigid support panel or layer. Although shown in FIG. 2 at the top of the seatback 110, rigid support block 200 may be positioned to support a trim cover at any location where voids may form between foam and plastic components, causing the trim cover to wrinkle at the void or sag into the void. The rigid support block 200 is more rigid than the foam cushion 130, and has a hardness greater than the foam cushion 130 in order to provide structural support for the trim cover (not shown). In certain embodiments, the rigid support block has a Shore Hardness of at least 50 Shore A, as measured according to ISO 868. In other embodiments, the Shore Hardness of the rigid support block 200 may be 50 to 100 Shore A, in yet other embodiments, 50 to 90 Shore A, and in other embodiments 50 to 80 Shore A. Furthermore, the rigid support block 200 has curved surface, as an arc of circle 230 (shown in FIG. 4B), such that the trim cover can be received smoothly without any sharp edges. The curved surface can be measured using a radial gauge to measure the radius of the arc the curved surface follows from an origin point in the rigid support block 200. The curved surface is on a region of the rigid support block facing away from the foam cushion, and provides a smooth edge to support the trim cover. Furthermore, the surface curvature measured by circle 230 follows a minimum radius of 3.2 mm such that the seatback complies with ECE R21. In some embodiments, the radius is 3.2 mm to 10 mm, and in other embodiments, 3.2 mm to 7 mm. Further, in certain embodiments, the radius is 3.2 mm to 5 mm. Without rigid support block 200, in conventional seatbacks, the foam cushion 130 may sag or have voids at junctures between the foam and other components, such as with the bezel. Rigid support block 200 can be positioned at the junctures between the foam and component, for example, at the upper end of the seatback where the bezel meets the foam cushion, to better support the trim cover.

The rigid support block 200 is formed of a structural foam material such as an expanded polymer including expanded polypropylene (EPP). The expanded polymer such as EPP may be prepared by a bead polymerization process in which relatively small uniform beads of polymer are produced, containing a gas which is later utilized to effect blowing during the molding process. The most commonly used gas is air although other gases including low boiling point liquids which produce gases at the molding temperatures may be used. The trim cover (not shown) can be mounted on the seatback 110 over the foam cushion 130 and the rigid support block 200. The rigid support block 200 provides a rigid layer at the top end of the seatback 110 to support the trim cover (not shown) such that wrinkling and sagging of the trim cover at the top portion of the foam is prevented. Furthermore, the support block 200 supports the trim cover rear of the bezel 300 to prevent wrinkling of the trim cover at the juncture between the bezel 300 and the foam cushion 130. Bezel 300 is made of any suitable material, such as, but not limited to, plastic.

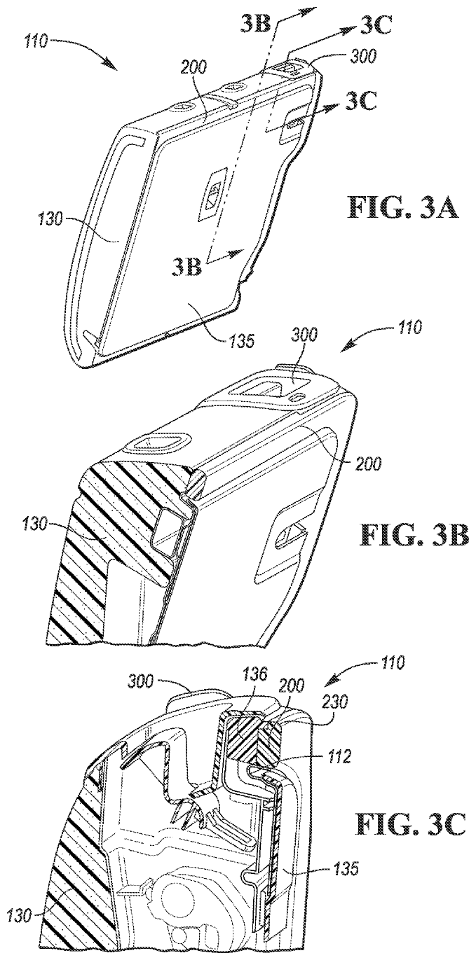

Support block 200 according to an embodiment is shown more in detail in FIGS. 3A-C, referred to hereafter. The seatback 110 includes foam cushion 130 and cover layer 135. The vehicle seatback 110 includes the rigid support block 220 disposed rearward of the foam cushion 130 at a top end of the seatback 110. However, the rigid support block 200 may be positioned at any juncture between components or void in foam to provide the structural support for the trim cover, and discussion of this embodiment is not intended to be limiting. The rigid support block 200 is shown at the top end as an exemplary embodiment, and the rigid support block 220 can be provided at any part of the vehicle seat where the foam is easily misshaped or a void is present due to the presence of a plastic component such that a trim cover would sag or wrinkle at the part of the vehicle seat. The rigid support block 200 is more rigid than the foam cushion 130, and has a hardness greater than 50 Shore (A or D) in order to provide structural support for the seatback 110 and trim cover (not shown). The rigid support block 200 may be an EPP support block. The rigid support block may be any size to fit desired styles, while still providing sufficient support to meet ECE R21. For example, in one or more embodiments, the support block 200 may extend the horizontally across the seatback, substantially across the top end, as per the design characteristics of the seatback (e.g., 60/40 or bucket seats). The rigid support block 200 may further include lateral wings 210 (at the lateral edges of the support block 200) extending down from the substantially horizontal portion 220 to support the trim material at the curvature of the corner of the seatback 110 at the corners. The dimensions of the rigid support block 200 may further vary per design specifications of the seatback. For example, in one or more embodiments, the rigid support block 200 has a height of 10 to 35 mm, in other embodiments 15 to 30 mm, and yet other embodiments 20 to 25 mm. Furthermore, in some embodiments, the rigid support block 200 has a width of 2 to 15 mm, in other embodiments, 5 to 10 mm, and in yet another embodiment 8 mm. As shown in FIGS. 3B-C, rigid support block 200 is disposed rearward relative to bezel 300. As shown in FIG. 3C, a portion 136 of foam cushion 130 is between bezel 300 and rigid support block 200. By incorporating rigid support block 200, where conventionally there would only be foam cushion 130, a trim cover (not shown) is better supported such that wrinkling is reduced between the bezel 300, portion 136 of foam cushion 130, and the rigid support block 200. Furthermore, as shown in FIGS. 4A-B, a section is taken along line C-C′, such that the curved surface of the rigid support block 200 and the minimum radius of curvature 230 is shown in detail.

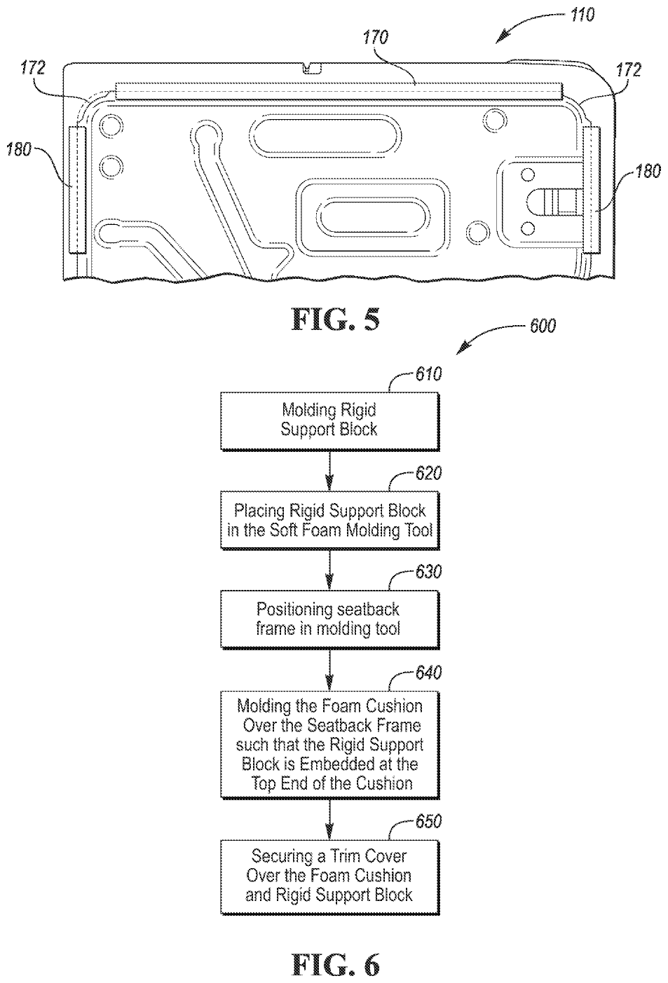

Referring to FIG. 5, a partial view of the top end of the seatback 110 is shown, without support block 200, according to an embodiment where the rigid support block 200 is at the top end of the seatback 110. Seatback frame, described above, is shown in FIG. 5 generally at reference numeral 170. Seatback frame 170 has corner edges extending down on the lateral edges on either side of the seatback 110. Lateral edges of the seatback frame 170 have trim retainers 180 disposed thereon for receiving and connecting the trim material (not shown) to the seatback 110. Rigid support block (not shown) is shaped to extend over the seatback frame 170 across the top of the seatback 110. The rigid support block further curves down toward the lateral edges of the seatback, over the frame corner edges 172 to further support the trim cover material at the edges (i.e., the rigid support block includes lateral wings that extend down from the horizontally extending portion). In conventional seatback, the trim cover wrinkles at the frame edge corner when soft foam is disposed over the frame. According to one or more embodiments, with the rigid support block extending down from the top end of the seatback 110, over the corner edges 172, toward the trim retainers 180, the trim material has a more rigid support thus preventing wrinkling and pinching at the corner.

As shown in FIG. 6, a method 600 of assembling a seatback is provided. First, the rigid support block is molded at step 610. The rigid support block may be molded with a curved surface for supporting the trim material. The curved surface of the rigid support block may have a minimum radius of 3.2 mm, thus in compliance with ECE R21 standards. Furthermore, the rigid support block may be molded as a panel, and may include winged lateral edges extending down from the panel. In some embodiments, such as for the top end of the seatback, the rigid support block is substantially horizontal, with the lateral wings extending down from the horizontal portion. However, the rigid support block may be any suitable shape to provide support for the trim cover at the top end of the seatback. The rigid support block may be formed of an expanded polymer such as EPP, and may be molded in a mold cavity by a bead polymerization process to form a rigid support. For example, foam beads may be injected into a mold tool and superheated with steam and sintered together. After cooling and stabilizing the formed and molded parts can be removed from the mold tool. However, any suitable mold process known to a person of ordinary skill in the art may be utilized to form the rigid support block.

The rigid support block is then positioned in the mold tool for the foam cushion in step 620. A seatback frame is also positioned in the mold tool at step 630. The foam cushion is then formed on the seatback frame in the mold at step 640. In step 640, because the rigid support block is positioned at the top end of the mold tool, it is embedded in the foam cushion at the top portion of the seatback. Thus, the rigid support block is embedded into the foam cushion at the top end for providing a rigid surface for receiving the trim material (discussed below at step 650) at the top end of the seatback, and furthermore, the winged lateral edges cover the seatback frame corners at the top corners of the seatback. However, the rigid support block can be placed at any suitable location requiring additional support in other embodiments. At step 650, a trim cover (comprising trim material) is secured over the foam cushion and rigid support block. The trim cover is supported by the rigid support block such that wrinkles are prevented from forming at the top end as well as at the corners of the seatback. The trim material may be secured to the foam cushion with clips of any other suitable securement device. In some embodiments the trim cover is attached to the foam cushion by hog rings, clips, fasteners or any other trim attachment known to a person of ordinary skill in the art. The trim material is wrapped around the seatback and attached to a trim trench formed on the frame in the foam cushion.

In one or more embodiments, a rigid support block for a vehicle seatback is disclosed. The rigid support block may be an EPP support block. The rigid support block has a curved surface, and supports a trim cover at the top end of a vehicle seatback such that risk of wrinkling is reduced. The rigid support block may be positioned at a top end of a seatback and also include winged lateral edges for wrapping down from a horizontal portion extending across the top end of the seatback, for covering frame edges of the seatback and preventing wrinkles at the corners. The rigid support block may provide impact support in compliance with ECE R21, as well as maintaining the aesthetic appearance of the trim cover on the seatback. A method of forming the seatback with the rigid support block is also described.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat assembly comprising:
a seat bottom;
a seatback pivotally attached to the seat bottom, the seatback comprising a foam cushion positioned on a seatback frame, the foam cushion having at least one plastic component embedded therein, and a rigid support panel embedded in the foam cushion proximate the at least one plastic component; and
a trim cover disposed over the seatback;
wherein the rigid support panel is positioned to support the trim cover over a void formed in the foam cushion at the at least one plastic component.

2. The vehicle seat assembly of claim 1, wherein the rigid support panel is positioned at a top end of the seatback and has a horizontal portion extending across the top end.

3. The vehicle seat assembly of claim 2, wherein the rigid support panel includes opposing end portions curving down away from the horizontal portion toward a bottom end of the seatback.

4. The vehicle seat assembly of claim 1, wherein the rigid support panel is an expanded polypropylene (EPP) support block.

5. The vehicle seat assembly of claim 4, wherein a Shore Hardness of the rigid support panel is greater than 50 Shore A.

6. The vehicle seat assembly of claim 5, wherein the Shore Hardness of the rigid support panel is 50 to 90 Shore A.

7. The vehicle seat assembly of claim 1, wherein the rigid support panel has a curved surface on a region facing away from the foam cushion for contacting the trim cover, the curved surface following an arc with a minimum radius of 3.2 mm.

8. The vehicle seat assembly of claim 7, wherein the curved surface follows an arc having a radius of 3.2 mm to 10 mm.

9. A vehicle seatback comprising:
a seatback frame having a top portion and a bottom portion opposite the top portion, the bottom portion configured to cooperate with a seat bottom;
a foam cushion disposed on the seatback frame, the cushion having a front side configured to support a passenger, and a rear side opposite the front side, and a top end and bottom end opposite the top end, corresponding with the top portion and bottom portion of the seatback frame, respectively;
a plastic component embedded in the foam cushion, the plastic component and foam defining a void therebetween; and
a rigid support panel more rigid than the foam cushion for supporting a trim cover, the rigid support panel being positioned over the void and the foam cushion.

10. The seatback of claim 9, wherein the rigid support panel is an expanded polypropylene (EPP) support block.

11. The seatback of claim 9, wherein the rigid support panel has a curved surface on a region facing away from the foam cushion for contacting the trim cover.

12. The seatback of claim 11, wherein the curved surface follows an arc having a minimum radius of 3.2 mm.

13. The seatback of claim 12, wherein the arc has a radius of 3.2 to 10 mm.

14. The seatback of claim 9, wherein the plastic component and rigid support panel are positioned at the top end of the seatback, and the rigid support panel extends across the top end.

15. The seatback of claim 9, wherein a Shore Hardness of the rigid support panel is greater than 50 Shore A.

16. The seatback of claim 15, wherein the Shore Hardness of the rigid support panel is 50 to 90 Shore A.

17. A method of manufacturing a seatback comprising:
molding a rigid support block for supporting a trim cover on the seatback;
positioning the rigid support block at a top end of a mold tool such that the rigid support block can be embedded in foam;
forming a foam cushion on a seatback frame in the mold tool, the foam cushion having a front side for supporting a passenger, a rear side opposite the front side, and a top end extending above the seatback frame corresponding to the top end of the mold tool; and
securing the trim cover over the foam cushion and rigid support block such that the trim cover is retained on the seatback.

18. The method of claim 17, wherein molding the rigid support block includes injection-molding expanded polypropylene (EPP) to form the rigid support block.

19. The method of claim 17, wherein molding the rigid support block includes forming a curved surface on a region of the rigid support block facing away from the foam cushion for supporting the trim cover.

20. The method of claim 19, wherein the curved surface follows an arc having a minimum radius of 3.2 mm.
